(19) United States
(12) Patent Application Publication
(10) Pub. No.: US 2011/0210098 A1
(43) Pub. Date: Sep. 1, 2011

(54) CONTROL OF A WELDING DEVICE

(76) Inventors: Denis Court, Eberbach (DE); Heinz-Ullrich Mueller, Michelstadt (DE); Volker Arndt, Erbach (DE); Juergen Haeufgloeckner, Schneeberg (DE); Michael Ripper, Ober-Kainsbach (DE)

(21) Appl. No.: 12/377,648

(22) PCT Filed: Jul. 5, 2007
(86) PCT No.: PCT/EP07/05931

§ 371 Date: May 23, 2011

(30) Foreign Application Priority Data
Aug. 18, 2006 (DE) 10 2006 038 786.4

(51) Int. Cl. B23K 11/30; B23K 11/00

(52) U.S. Cl. 219/117.1; 219/119

(57) ABSTRACT

A method for operating a welding device (1), wherein the welding device has at least one welding electrode (4), which is operated with at least one variable electrical reference value and wherein this electrical reference value is controlled by a control device (6), wherein the control of the electrical reference value takes place with allowance being made for a set of reference data (25) that is characteristic of a welding operation to be carried out. According to the invention, the set of reference data (25) is determined on the basis of at least one set of raw data (23a, 23b, 23c, 23d), wherein this set of raw data (23a, 23b, 23c, 23d) is characteristic of the welding operation to be carried out.

The present invention relates to a method and device for operating a welding device and in particular, a pressure resistance welding device.

A variety of welding devices and welding methods are known from the prior art. Particularly in the automotive industry, predominantly electric welding devices are used. Such electric welding devices have two welding electrodes between which a welding current flows, which current is used to weld a work piece awaiting assembly. The welding current is normally supplied by a converter. Usually, currents of up to 20 kA at welding voltages in the range from 1-2.5 V are used for the welding, but the current can also exceed these values depending on the material used for the welding task. The individual welding procedures usually take place within timeframes in the range of up to one second, but can also take longer.

In the prior art, the welding procedures have always been carried out using constant welding currents. It turns out, however, that in many cases, it makes sense to change the welding current in order to be able to ideally carry out the welding procedure in its entirety, i.e. over the whole time that it is being executed. Correspondingly, it is known from the prior art to regulate the welding current and other characteristic values of the welding procedure by means of a regulator. This regulator accesses a reference curve that is characteristic for the corresponding welding procedure. Up to now, this reference curve, which the adaptive regulator requires for the regulating and monitoring operation, has been stored as an individual curve in a regulating module. This reference curve is recorded by means of a reference welding procedure that takes place before the actual work procedures.

But this runs the risk that a non-optimal reference curve will be stored in the regulating module as a basis for the regulation, which would result in the regulator not functioning optimally. Reasons for the existence of such non-optimal curves include, for example, cases of weld spatter, severely worn electrode caps, freshly milled electrode caps, and other disturbance variables.

Consequently, in the methods known from the prior art, the reference curve is a function of the current system state (for example the wear state of the electrode caps), i.e. the current system state is a crucial factor in the ability to produce an optimal reference curve.

For example, if a process variable such as the cooling, the force of the welding tongs, etc. is not stable at the moment that the reference weld is produced, then this unsatisfactory state will also be learned as a reference.

In this case, the regulator is incorrectly referenced and is therefore unable to function optimally.

In addition, many types of sheet metal have a large distribution range, for example of resistance curves. This distribution cannot be counteracted with only one curve that is used as a reference curve. In other words, establishing a stable process range within which a suitable reference curve must lie is not possible because no comparison to other curves is carried out.

The object of the present invention, therefore, is to create a method and welding apparatus that permit an improved adaptation to different system conditions. More precisely stated, a method and device should be created that permit an improved referencing of the regulator. In addition, a method and device should be created that permit a monitoring of welding procedures.

This object is attained according to the invention by means of a method according to claim 1 and a welding device according to claim 11. Advantageous embodiments and modifications are the subject of the dependent claims.

In the method according to the invention for operating a welding device, in which the welding device has at least one welding electrode and preferably two welding electrodes that is (are) operated with a current that has at least one variable electrical reference value and the electrical reference value is controlled by means of a control unit, the control of the electrical reference value is carried out taking into account a reference data set that is characteristic for a welding procedure to be carried out. According to the invention, the reference data set is determined on the basis of at least one raw data set, where this raw data set is characteristic for the welding procedure to be carried out.

An electrical reference value is understood in particular to be one of the parameters or values that characterize the electrical current. Preferably, the electrical reference value is selected from a group of reference values that includes the welding current, the welding voltage, the power output, the energy, the phase angle, combinations of these, and the like, in particular the welding current.

The present invention also relates to a method for controlling and/or monitoring a welding device in which the welding device has at least one welding electrode that is operated with at least one electrical reference value and in which this electrical reference value is controlled by means of a control unit. The control of the electrical reference value is carried out taking into account a reference data set that is characteristic for a welding procedure to be carried out. According to the invention, the reference data set is compared to at least one raw data set that is characteristic for the measuring procedure to be carried out and based on this comparison, a conclusion is drawn about the welding procedure carried out.

The comparison of the raw data set to the reference data set permits a conclusion to be drawn about whether a weld has been correctly carried out. For example, if the raw data set deviates significantly from the reference data set, then it is possible to conclude that an incorrect weld has been carried out. This makes it possible to monitor welding procedures. Thus in both methods according to the invention, raw data sets are established and used for monitoring and controlling the welding procedure.

Preferably, a distribution range around the reference data set is determined, If raw data sets lie within this distribution range, then the correspondingly executed welds can still be viewed as correct. If the established raw data sets lie (partially) outside this distribution range, then the welding procedure is no longer correct.

Preferably, the electrical reference value is regulated by means of a regulating device. It should be noted, however, that the present method can be used not only to regulate reference values but also to monitor welding procedures.

Preferably, the reference data set is determined from a large number of raw data sets, with each raw data set being characteristic for the welding procedure to be carried out. In particular, however, this method is not exclusively limited to an averaging over several raw data sets.

The reference data set is also referred to below as the reference curve. This reference curve describes a specific welding procedure and for example contains data pairs such as characteristic values for welding currents as a function of the time at which the measurement takes place.

Consequently in connection with the present description, a data set that is characteristic for the welding procedure to be carried out is in particular understood to be a data set that has been recorded for a welding procedure that is the same or similar. A specific data set is thus characteristic for a welding procedure that has been carried out with specific welding electrodes on a specific material to be welded or on a similar material.

The use of a multitude of raw data sets that are likewise characteristic for the welding procedure to be carried out makes it possible to establish a reference data set that eliminates outliers resulting from incorrect measurements. In addition, this method makes it possible to determine an average reference data set that more precisely describes the welding procedure to be carried out.

In other words it is possible, for example by expanding the corresponding user interfaces of the welding device, to take steps to counteract the above-mentioned imponderables.

With the new functionality according to the invention, particularly during continuous production, welds are automatically recorded over a certain time period for each program or for each weld point and stored, for example, in the PC or in the welding control unit. In other words, a multitude of welding procedures are recorded, which permit a subsequently improved output of the reference data set.

After this recording is completed, families of curves (e.g. resistance curves) are available to the user for each welded program or for each weld point (for each individual control unit and each program in networked systems). Based on these families of curves, the user can detect outliers such as cases of weld spatter or interrupted welds and delete them, for example at the click of a mouse. It is also possible, however, for this detection and deletion to occur in an automated fashion.

In addition, the user can identify the stable process range and can better estimate the position of the reference curve to be produced.

After elimination of the above-mentioned outliers, the family of curves can then be determined and stored as a reference data set in the regulating module of the welding control unit.

This assures that the reference data set is situated in the middle of the above-mentioned process range or in general, at a position to be determined by the user. In the determination of the above-mentioned family of curves, all of the measured or derived values are advantageously averaged, e.g. the current, the voltage, the phase angle, the resistance, the power output, and the energy.

In a preferred method, the reference data set contains a multitude of pairs of variates, for example a time value that is plotted in relation to a resistance value.

Preferably, the reference data set is produced by carrying out a mathematical operation on at least one raw data set and particularly preferably on at least a portion of the raw data sets. This operation can include averaging operations and the like. In particular, the mathematical operation is selected from among a group of mathematical operations that includes averaging operations, in particular arithmetic or geometric averaging operations, integral operations, summations, combinations of these, and the like. Preferably, arithmetic averaging operations are used to average the individual raw data sets and thus to produce the reference data set. The carrying out of the mathematical operation on only one raw data set is in particular a smoothing of this raw data set, but is not limited exclusively to this.

In another preferred method, the pairs of variates each include a first value and at least one second value associated with this first value. It is also possible, however, for a first value to be associated with several second values, for example a current value, a voltage value, a resistance value derived from them, a value for the phase angle, and values for power output and energy. Instead of pairs of variates, such a case would involve n-tuple variates.

Preferably, the mathematical operation is carried out on the second values of the different raw data sets that are each associated with the same first value. Thus, for example, a specific first value such as the time value in a predetermined raw data set is associated with a specific resistance value. These resistance values, i.e. the second values, are then arithmetically averaged and the corresponding average is used as a basis for the reference data set at the predetermined time value. Therefore, at the above-mentioned first value, the reference data set includes the average associated with it.

Preferably, the number of raw data sets that are used to determine the reference data set lies between 1 and 1000, preferably between 5 and 200, particularly preferably between 10 and 100, and most particularly preferably between 15 and 40. The determination of this number must on the one hand take into account the fact that as the number increases, the precision of the reference data set also increases. On the other hand, particularly when the raw data sets are processed manually, it is necessary to take into account the fact that an excessively large a number of data sets would be impossible for a user to process.

In another preferred embodiment, the welding device can be operated in a multitude of programs and a reference data set is produced in each of these programs. Different programs are understood in this context to be different welding programs, for example for different types of material. In each of these welding programs, it is possible to produce a multitude of respective raw data sets from which the reference data set is in turn produced.

In another preferred method, at least a portion of the different raw data sets are weighted differently in the determination of the reference data set. It is thus possible, for example, for raw data sets that are implausible or contain outliers to be weighted differently. In particular, it is also possible for individual raw data sets to be weighted with the factor 0, i.e. for them not to be considered in the determination of the reference data set. It is also possible for individual data values within the raw data sets to be left out of consideration in the determination of the reference data set.

In another preferred method, a weighting of this kind occurs automatically. It is thus possible, for example, to detect outliers in the raw data sets, for example through a differentiation or through gradient calculation, and when such outliers are present, to completely eliminate the corresponding raw data set from the average calculation.

The present invention also relates to a welding device with a first welding electrode, a second welding electrode that cooperates with the first welding electrode, and a supply unit that supplies an electric current to the welding electrodes in which at least one reference value of this electric current is variable. This welding device also has a measuring device that determines at least one electrical value that is characteristic for the electrical reference value of the current supplied to the electrodes and has a control unit that controls the electrical reference value as a function of the characteristic measurement value. In this case, the control unit controls the electrical reference value by taking into consideration a reference data set that is characteristic for a welding procedure to be carried out. According to the invention, the welding device or a PC associated with this electrical welding device has a storage device in which at least one raw data set is at least temporarily stored, said raw data set being characteristic for the welding procedure to be carried out. A processor unit is also provided, which determines the reference data set from at least one raw data set and/or compares at least one raw data set to the reference data set.

Preferably, the electrical reference value is selected from a group of reference values that includes the welding current, the welding voltage, the power output, the energy, the phase angle, combinations of these, and the like, in particular the welding current.

Preferably, the processor unit determines the reference data set based on a multitude of raw data sets or a portion of the raw data sets.

In addition, a multitude of raw data sets are at least temporarily stored in the storage device, with each raw data set being characteristic for the welding procedure to be carried out.

In a preferred embodiment, the measuring device is a current-measuring device that measures the welding current.

In a particularly preferred embodiment, the welding device has a switch mechanism with the aid of which it is possible to switch from a first mode in which the raw data sets are read into the storage device, into a second mode in which a welding procedure can be carried out taking into account the reference data sets. In particular, this second mode is the working mode in which the welding procedures are carried out. For example, the switch mechanism can be a mechanical switch; it is also possible, however, for a software-based switch to be provided or also for a switch mechanism to be provided, for example in the form of sensor elements, screen elements, or the like.

Preferably, the welding device has a calibration mode in which a reference data set can be produced from a multitude of raw data sets.

The present invention also relates to a welding device that is operated with a method of the type described above.

Other advantages and embodiments ensue from the accompanying drawings:

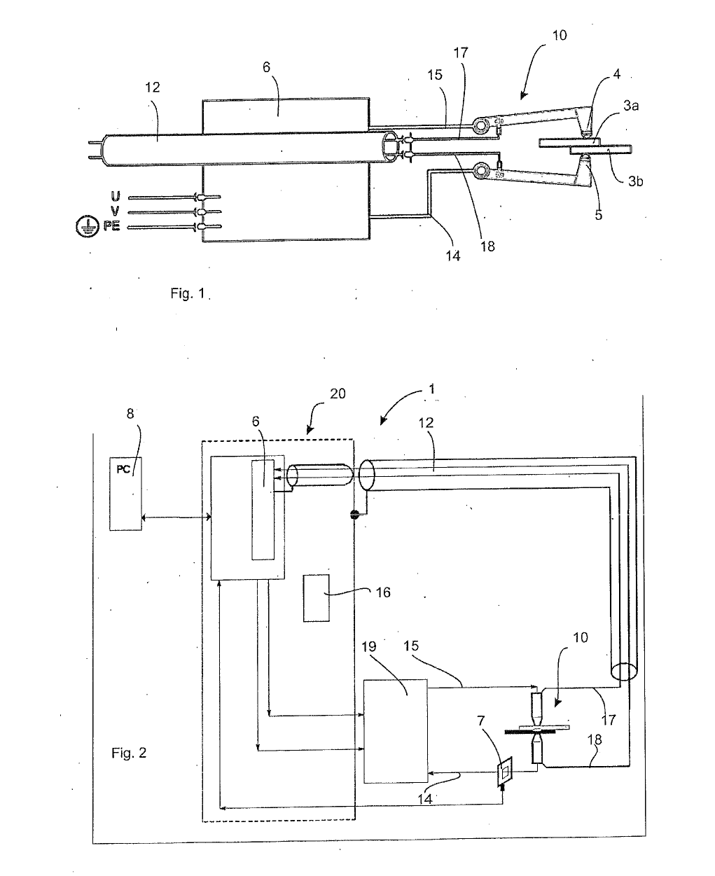

FIG. 1 is a schematic depiction of a part of a welding device;

FIG. 2 is a block circuit diagram of a welding device according to the invention;

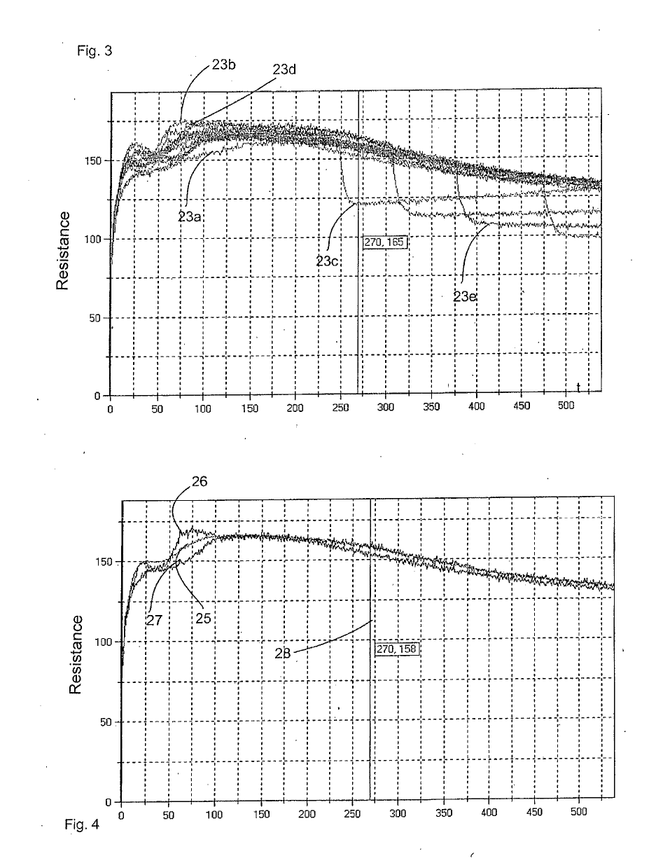

FIG. 3 is a graphical depiction of a multitude of recorded raw data sets;

FIG. 4 is another depiction of a multitude of raw data sets; and

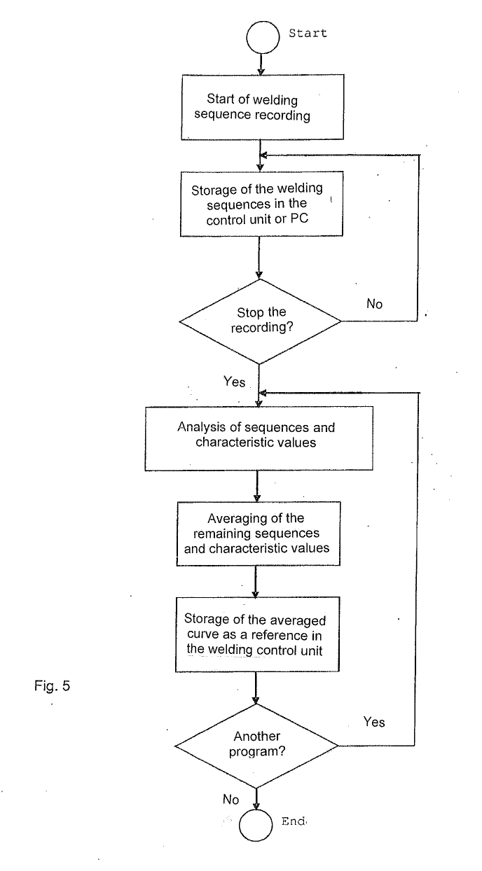

FIG. 5 is a flowchart of a method according to the invention.

FIG. 1 is a schematic depiction of a welding device 1. This welding device 1 has a pair of welding tongs 10. The pair of welding tongs 10 includes two electrodes 4, 5 that are used to weld two surfaces or two or more work pieces 3a, 3b. The welding tongs are supplied with the welding current via the power supply lines 14, 15, The voltage measurement lines 17, 18 or electrode voltage cables are used for voltage measurement. These electrode voltage cables 17, 18 can be brought into contact with the tong arms and should be routed so that they do not hinder the movement of the welding tongs 10. Since these cables are moved along with the movement of the tongs, a highly flexible cable should be used for the electrode voltage cables 17, 18.

Only one wire or one voltage measuring cable is connected to each of the respective tong arms. For this reason, the cable can be embodied as unshielded in this region. As they continue, however, the voltage cables 17, 18 are routed together with other lines and therefore at this location, shielding 12 is required. This shielding is in turn connected to ground potential in order to effectively shunt interference to the outside.

FIG. 2 is a schematic depiction of a welding apparatus. The reference numeral 8 indicates a user interface that can be provided, for example, on a PC. The reference numeral 20 indicates the control unit for the welding tongs, for example in the form of a switch cabinet. The reference numeral 10 in turn indicates the welding tongs.

The reference numeral 7 indicates to a measuring device for measuring the welding current I_{weld}. In addition, with the aid of the shielding 12 and another voltage measuring device (not shown), the voltage is measured in order to thus determine the resistance as a function of time (as a derived value). This welding resistance is composed of material resistances and contact resistances. The material resistances depend on the material and state of the welding electrodes themselves as well as on the two materials to be welded. The contact resistances are a function of the welding process itself, i.e. in particular the contacting surfaces, the weld nugget or welding seam produced, and the welding electrodes.

The reference numeral 6 here refers to the regulator, i.e. a current/voltage regulator, and the reference numeral 19 refers to a transformer.

With the aid of the design according to the invention, it is possible to consult several welds of a program, said welds being independent of the sequence in which the programs are run. It is also possible to simultaneously record a plurality of welds in a plurality of welding control units, which significantly simplifies the establishment of the reference data sets in actual practice.

FIG. 3 is a graph depicting a multitude of such raw data sets or raw curves 23a, 23b, 23c, 23d, 23e. In the graph, the resistance resulting from the measured current and voltage values is plotted over the time of the welding procedure.

The graph shows that a multitude of raw data sets are produced for one welding procedure. These individual raw data sets are read into a storage device 16 (see FIG. 2) in a recording mode. On the one hand, it is possible to carry out the recording here so that raw data sets that have already been recorded are deleted. It is, however, also possible to retain already recorded raw data sets and to continue the recording of additional raw data sets.

Preferably, it is possible to monitor the recording of the raw data itself and the progress of this directly on the PC. After a particular recording is completed, which is indicated in a status display, the recording can be stopped and the process can be switched into an analysis mode, which after the recording of all of the raw data, can serve to establish the reference data sets, for example.

With the aid of suitable filters or suitable programs, it is possible to display all of the recorded curves, as shown in FIG. 3. During the processing, it is possible to select a specific curve, in this case for example curve 23d, for further processing. The user now has the option of displaying this curve alone, i.e. hiding the remaining curves 23a, 23b, 23c. If this curve, i.e. this raw data set 23d, turns out to be unsuitable for further use, for example because it characterizes a weld spatter measurement, then this data set and this curve 23d can be deleted. It is also possible to delete or correct individual measurement points and outliers in the curve 23d, for example as part of a smoothing of the curve.

It is also possible to smooth individual curves 23d through the use of specially adapted algorithms. In any case, curves and raw data sets of weld spatters and other outliers can be deleted at this stage of the process. Raw data sets of this kind are indicated by the reference numerals 23c and 23e in FIG. 3 and are recognizable by the suddenly falling flank of the resistance curve. Consequently, it is also possible for such raw data sets to be automatically identified and deleted, for example by taking into account the gradient of such raw data sets.

In another process step, an averaging of the remaining curves or raw data sets can be carried out in order to thus establish the appropriate reference curve for a program or welding point. This procedure is depicted in FIG. 4. The reference numeral 25 here indicates the averaged curve, i.e. the reference curve or reference data set for the program.

The two curves 26 and 27 above and below it are the minimum and maximum resistance curves. For these resistance curves, it is possible on the one hand to use the very highest and lowest curves, respectively; it is also possible, however, to use the maximum and minimum resistances that correspond to a particular time value. The designation of these maximum and minimum resistance curves is particularly of interest for obtaining a measure for the dispersion of the measurement values. It is also possible to designate the corresponding dispersions or variances in order to thus obtain an image over the dispersion curve of the measurement.

The vertical line 28 shows a value singled out as an example, i.e. the time value 270 indicated in the graph and the resistance value 158 corresponding to it.

As the process continues, it is possible for the curve 25 depicted here to be shown contrasted with the raw data sets or also to be switched back to the original curve position.

In another process step, the reference data set that has now been determined is stored as a reference curve for this particular program in the welding control unit 6 (with regulator). In the other respective work programs, the determined raw data sets can be handled in the same way. It should be noted that in the present depiction, the determination of the reference data set has been depicted in the example of a resistance measurement. It is correspondingly also possible, however, to take measurements for the power output, energy, and phase angle values in order to produce corresponding reference data sets here, too.

FIG. 5 is a flowchart for illustrating the entire course of the process. In a first process step, the recording of welding procedures is begun and the individual welding procedures and raw data sets are stored in the control unit or the PC 8. The recording can be stopped through a corresponding input by the user. After a multitude of welding procedures have been recorded, the individual curves and characteristic values can be analyzed by the user or also analyzed automatically. In particular, it is possible to eliminate outliers, for example due to cases of weld spatter. In the next process step, the rest of the remaining curves and characteristic values are averaged and the resulting averaged curve is stored as a reference in the welding control unit. This process can be repeated for different welding programs.

All of the defining characteristics disclosed in the application documents are claimed as essential to the invention, provided that they are novel, either individually or in combination with one another, in comparison to the prior art.

### REFERENCE NUMERAL LIST

1 welding device
3a, 3b work piece
4 electrode
5 electrode
6 welding control unit
7 measuring device
8 PC
10 welding tongs
12 shielding
14, 15 power supply line
16 storage device
17, 18 voltage measurement line
19 transformer
20 control unit for welding tongs
23a, b, c, d, e raw data sets or raw curves
25 reference data set or reference curve
26 maximum resistance curve occurring
27 minimum resistance curve occurring
28 vertical line
I_{weld} welding current

What is claimed is:

1. A method for controlling and/or monitoring a welding device (1), in which the welding device (1) has at least one welding electrode (4) that is operated with at least one changeable electrical reference value, this electrical reference value is controlled by means of a control unit (6), and the control of the electrical reference value is carried out taking into account a reference data set (25) that is characteristic for a welding procedure to be carried out,
wherein the reference data set (25) is determined on the basis of at least one raw data set (23a, 23b, 23c, 23d) and this raw data set (23a, 23b, 23c, 23d) is characteristic for the welding procedure to be carried out.

2. A method for controlling and/or monitoring a welding device (1), in which the welding device (1) has at least one welding electrode (4) that is operated with at least one electrical reference value, this electrical reference value is controlled by means of a control unit (6), and the control of the electrical reference value is carried out taking into account a reference data set (25) that is characteristic for a welding procedure to be carried out,
wherein the reference data set (25) is compared to at least one raw data set (23a, 23b, 23c, 23d) that is characteristic for the measuring procedure to be carried out and, based on this comparison, a conclusion is drawn about the welding procedure carried out.

3. The method as recited in claim 1,
wherein the electrical reference value is selected from a group of reference values that includes the welding current (I_{weld}), the welding voltage, the power output, the energy, the phase angle, combinations of these, and the like, in particular the welding current (I_{weld}).

4. The method as recited in claim 1,
wherein the reference data set (25) is determined from a multitude of raw data sets (23a, 23b, 23c, 23d) and each raw data set (23a, 23b, 23c, 23d) is characteristic for the welding procedure to be carried out.

5. The method as recited in claim 1,
wherein the reference data set (25) contains a multitude of pairs of variates.

6. The method as recited in claim 1,
wherein the reference data set (25) is produced by carrying out a mathematical operation on at least one raw data set (23a, 23b, 23c, 23d).

7. The method as recited in claim 6,
wherein the mathematical operation is selected from a group of mathematical operations that includes averaging operations, in particular arithmetic or geometric averaging operations, integral operations, summations, smoothing operations, combinations of these, and the like.

8. The method as recited in claim 1,
wherein the pairs of variates each include a first value and at least one second value associated with this first value.

9. The method as recited in claim 5,
wherein the mathematical operation is carried out on the second values of the different raw data sets (23a, 23b, 23c, 23d) that are each associated with the same first value.

10. The method as recited in claim 1,
wherein the number of raw data sets (23a, 23b, 23c, 23d) that are used to determine the reference data set (25) lies between 1 and 1000, preferably between 5 and 200, particularly preferably between 10 and 100, and most particularly preferably between 15 and 40.

11. The method as recited in claim 1,
wherein the welding device (1) is operable in a multitude of programs and a reference data set (25) is produced in each of these programs.

12. The method as recited in claim 1,
wherein at least a portion of the different raw data sets (23a, 23b, 23c, 23d) are weighted differently in the determination of the reference data set.

13. The method as recited in claim 9,
wherein the weighting takes place automatically.

14. A welding device (1) having a first welding electrode (4), having a second welding electrode (5) that cooperates with the first welding electrode, having a supply unit that supplies an electric current (I_{weld}) to t the welding electrodes (4, 5) during a welding procedure, at least one reference value of this electric current (I_{weld}) being variable, having a measuring device (7) that determines at least one electrical value that is characteristic for the electrical reference value of the current supplied to the electrodes, and having a control unit (6) that controls the'electrical reference value as a function of the characteristic measurement value, said control unit (6) controlling the electrical reference value by taking into consideration a reference data set (25) that is characteristic for the welding procedure to be carried out,
wherein the welding device has a storage device (16) in which at least one raw data set (23a, 23b, 23c, 23d) is stored, said raw data set (23a, 23b, 23c, 23d) being characteristic for the welding procedure to be carried out, and also has a processor unit that determines the reference data set (25) on the basis of at least one raw data set (23a, 23b, 23c, 23d).

15. The device as recited in claim 14,
wherein the electrical reference value is selected from a group of reference values that includes the welding current I(_{weld}), the welding voltage, the power output, the energy, the phase angle, combinations of these, and the like, in particular the welding current (I_{weld}).

16. The device as recited in claim 14,
wherein the measuring device (7) is a current-measuring device (7) that measures the welding current (I_{weld}).

17. The device as recited in claim 14,
wherein the processor unit determines the reference data set (25) on the basis of a multitude of raw data sets (23a, 23b, 23c, 23d).

18. The device as recited in claim 14,
wherein the welding device (1) has a switch mechanism with the aid of which it is possible to switch from a first mode in which the raw data sets (23a, 23b, 23c, 23d) are read into the storage device (16), into a second mode in which it is possible to carry out a welding procedure taking into account the reference data set (25).

19. The device as recited in claim 14,
wherein the welding device (1) has a calibration mode in which it is possible to produce a reference data set (25) on the basis of a multitude of raw data sets (23a, 23b, 23c, 23d).
